(19) United States
(12) Patent Application Publication
(10) Pub. No.: US 2026/0312745 A1
(43) Pub. Date: Oct. 8, 2026

(54) BEAM PREDICTION AND QUASI-CO-LOCATION ASSUMPTIONS FOR ARTIFICIAL INTELLIGENCE ENABLED BEAM MANAGEMENT

(71) Applicant: Apple Inc., Cupertino, CA (US)

(72) Inventors: Weidong Yang, San Diego, CA (US); Yang Tang, San Jose, CA (US); Dawei Zhang, Saratoga, CA (US); Wei Zeng, Saratoga, CA (US); Oghenekome Oteri, San Diego, CA (US); Haitong Sun, Cupertino, CA (US)

(21) Appl. No.: 19/481,459

(22) PCT Filed: Apr. 10, 2024
(86) PCT No.: PCT/US2024/023923

§ 371 Date: Nov. 4, 2025

Related U.S. Application Data
(60) Provisional application No. 63/466,163, filed on May 12, 2023.

(51) Int. Cl. H04L 5/00

(52) U.S. Cl. CPC H04L 5/0026; H04L 5/0051; H04L 5/0091

(57) ABSTRACT

A user equipment (UE) includes a transceiver and a processor. The processor is configured to receive, via the transceiver, an indication of a set of transmit (Tx) beams of a network device. The processor is also configured to generate a set of measurements based on a set of reference signals. The set of reference signals is received via the transceiver and from the network device on at least one beam of the set of Tx beams. The processor is further configured to determine, at least partly based on the set of measurements and using artificial intelligence (AI), a set of predicted Tx beams that is best received by the UE. The set of predicted Tx beams includes one or more Tx beams outside the set of Tx beams. The processor is also configured to transmit, via the transceiver, a report identifying the set of predicted Tx beams.

### CROSS-REFERENCE TO RELATED APPLICATION

This Patent Cooperation Treaty patent application claims priority to U.S. Provisional Patent Application No. 63/466,163, filed May 12, 2023, and titled “Beam Prediction and Quasi-Co-Location Assumptions for Artificial Intelligence Enabled Beam Management,” the contents of which are incorporated herein by reference in its entirety.

### TECHNICAL FIELD

This application relates generally to wireless communication systems, including systems in which a user equipment (UE) uses artificial intelligence (AI) to make one or more beam predictions (e.g., transmit (Tx) beam predictions and/or receive (Rx) beam predictions).

### BACKGROUND

Wireless mobile communication technology uses various standards and protocols to transmit data between a network device (e.g., a base station, a radio head, etc.) and a wireless communication device. Wireless communication system standards and protocols can include, for example, 3GPP long term evolution (LTE) (e.g., 4G), 3GPP NR (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, or simply a node) and a wireless communication device known as a UE. 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device used by a RAN may correspond to that RAN. One example of an E-UTRAN network device is an Evolved Universal Terrestrial Radio Access Network (E-UTRAN) Node B (also commonly denoted as evolved Node B, enhanced Node B, eNodeB, or eNB). One example of an NG-RAN network device is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 shows an example method of wireless communication by a UE, according to embodiments described herein.

FIG. 3 shows a Tx beam Set A and a Tx beam Set B, according to embodiments described herein.

FIG. 4 shows an example of a report including predicted Tx beams that may be transmitted by a UE, according to embodiments described herein.

FIG. 5 shows the Tx beam Set A and Tx beam Set B shown in FIG. 3, along with a predicted Tx beam on which a reference signal may be transmitted/received, according to embodiments described herein.

FIG. 6 shows an example mapping of Tx beams in a Tx beam Set B to quasi-co-location (QCL) information associated with a transmission configuration indicator (TCI) state, according to embodiments described herein.

FIG. 7 shows an example mapping of QCL information to a TCI state, according to embodiments described herein.

FIG. 8 shows three example reports of predicted Tx beams, which reports may be transmitted by a UE at the same time, according to embodiments described herein.

FIG. 9 shows an example method of wireless communication by a network device, according to embodiments described herein.

FIG. 10 illustrates an example architecture of a wireless communication system, according to embodiments described herein.

FIG. 11 illustrates an example system for performing signaling between a wireless device and a network device, according to embodiments described herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

AI enabled beam management can potentially provide sharper (or narrower, more focused) beams than what is possible with non-AI beam management. For purposes of this description, AI is defined as a computer-based technology that solves tasks that typically require human intelligence. Machine learning (ML) is defined as a subset of AI, and more particularly is defined as a computer-based technology that solves specific tasks by learning from data and making predictions. References in this description to Al are intended to also refer to ML (as a subset of AI).

With non-AI (or conventional) beam management for Tx beams, a UE is provided with a number of measurement resources upon which the UE performs measurements and reports a reference signal received power (RSRP) or signal-to-interference plus noise ratio (SINR), depending on whether ‘cri-RSRP’, ‘ssb-Index-RSRP’, ‘cri-SINR’, or ‘ssb-Index-SINR’ is configured. As the number of channel state information (CSI) reference signal (CSI-RS) resources is configured, the reference to a CSI-RS can be through its CSI-RS resource identifier (ID).

With AI enabled beam management for Tx beams, a UE can predict a best Tx beam (e.g., a beam having a particular horizontal beam angle and a particular vertical beam angle). In some cases, AI may predict a Tx beam that is capable of being formed by a network device (e.g., a gNB), but which does not correspond to a CSI-RS resource configured by the network device. Described herein are various techniques for conducting beam management in such a use case.

In addition to AI being able to predict a Tx beam that does not correspond to a configured CSI-RS resource, QCL assumptions for such a beam may not be defined and may need to be configured, deduced, or inferred. A QCL assumption is information provided by a network device, to a UE, so that the UE can make proper assumptions regarding parameters such as Doppler shift, Doppler spread, average delay, delay spread, and a spatial Rx parameter, and appropriately configure its hardware or software. The spatial Rx parameter indicates, for example, the Rx beam and/or Rx panel (i.e., antenna panel) that the UE should use to receive a particular signal or channel (e.g., a CSI-RS, a physical downlink control channel (PDCCH), or a physical downlink shared channel (PDSCH)). To facilitate the definition of QCL assumptions, a “family tree” of QCL assumptions (or chain of QCL assumptions) may be defined, thereby enabling the QCL assumptions for downstream or child signals or channels to be derived from the QCL assumptions for one or more upstream or parent signals or channels. When a UE predicts a Tx beam, a network device or UE may need to configure, deduce, or infer the appropriate QCL assumptions for signals or channels transmitted/received on the predicted Tx beam. Currently, there is no framework for doing this.

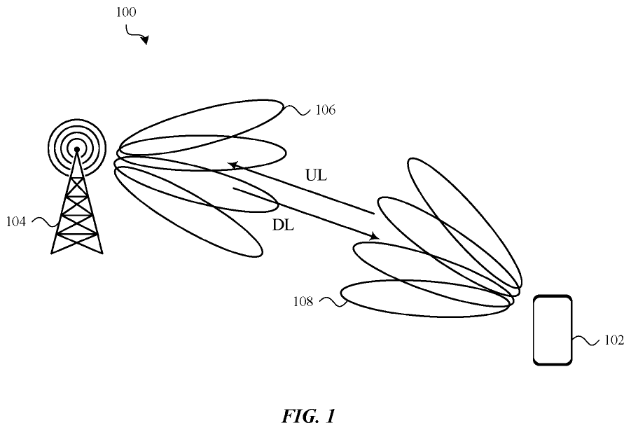

FIG. 1 shows an example wireless communications system 100. The wireless communications system may include a UE 102 that is connected, over the air, to a network (e.g., a 3GPP network). The UE 102 may communicate with the network on one or more uplink (UL) channels and one or more downlink (DL) channels, and more particularly may communicate with one or more network devices of a RAN (e.g., network device 104, which may take the form of a base station (e.g., gNB), remote radio head, etc.) on the one or more UL channels and DL channels. Depending on the capabilities of the UE 102 and the UE's configuration by the network, the UE 102 may communicate with one or more network devices 104 simultaneously, contemporaneously (e.g., in a multiple input multiple output (MIMO) mode), or sequentially (e.g., when handed over).

In some embodiments (e.g., NR FR2 embodiments), the network device 104 may transmit on one or more Tx beams 106. Optionally, the UE 102 may receive on one or more Rx beams 108. Before communicating over a particular Tx/Rx beam pair, the UE 102 may perform measurements on one or more measurement resources transmitted on one or more Tx beams 106 of the network device 104. In some cases, the network device 104 may be capable of transmitting on many Tx beams 106, but may configure measurement resources on only some of its Tx beams for a UE to measure. Configuring measurement resources on all of its Tx beams may require too much overhead and delay, and may waste the power of the UE 102.

The techniques described herein enable a UE (e.g., the UE 102) to receive measurement resources (or reference signals) on a subset of a network device's Tx beams; predict a best Tx beam on which the UE may receive a signal or channel (which best Tx beam may not be one of the Tx beams on which the UE receives measurement resources); and determine QCL assumptions for the predicted Tx beam.

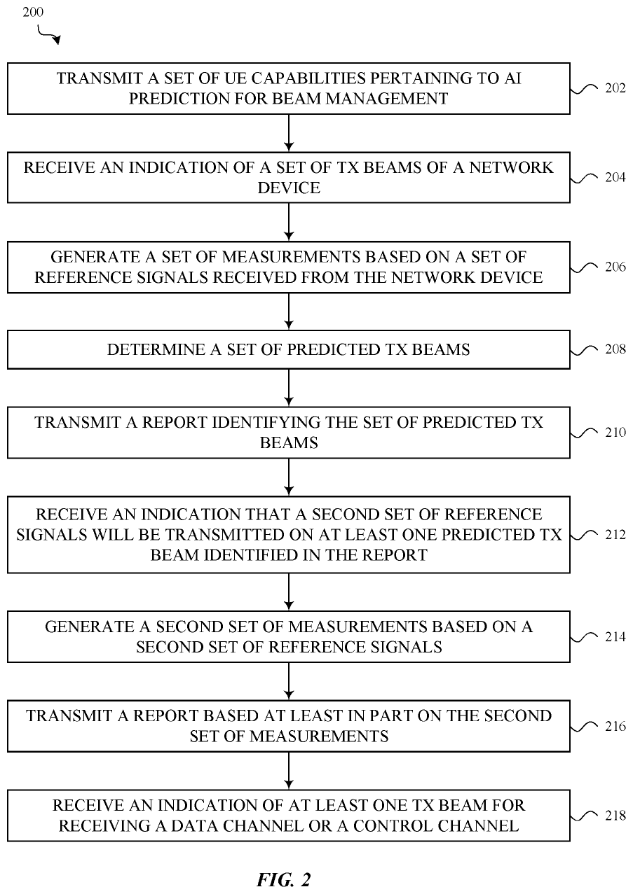

FIG. 2 shows an example method 200 of wireless communication by a UE. In some cases, the UE may be the UE described with reference to FIG. 1 or one of the other UEs described herein. The method 200 may be performed using a transceiver (or radio), a processor, or other components of the UE.

At 202, the method 200 may optionally include transmitting, via the transceiver (and in some cases to a network device), a set of UE capabilities pertaining to AI prediction for beam management. The set of UE capabilities may indicate, for example, whether the UE is configured to make an AI prediction for beam management; the inputs that the UE's AI prediction model needs or can use; the outputs that the UE's AI prediction model produces; and so on. The set of UE capabilities may be transmitted, for example, in radio resource control (RRC) signaling or in one or more medium access control (MAC) control elements (MAC CEs).

At 204, the method 200 may include receiving, via the transceiver, an indication of a set of Tx beams of the network device. In some embodiments, the indication of the set of Tx beams may include a first indication of a first set of Tx beams (e.g., a Tx beam Set A) on which the network device is configured to transmit. The Tx beams in the first set of Tx beams may be Tx beams to which the network device has assigned beam identifiers (IDs). It is noted that a beam ID can be in the form of a CSI-RS resource index (e.g., NZP-CSI-RS-ResourceId), synchronization signal block (SSB) index (e.g., SSB-Index), or TCI state index (e.g., TCI-StateId in 3GPP TS 38.331). In some embodiments, the indication of the set of Tx beams may also or alternatively include a second indication of a second set of Tx beams (e.g., a Tx beam Set B) on which the network device is or will be transmitting reference signals (e.g., CSI-RS) that the UE can measure for purposes of beam management or other purposes. The Tx beam Set B may be a subset of the Tx beam Set A. In some embodiments, the indication of the set of Tx beams may indicate, for at least one Tx beam in the set of Tx beams of the network device, a horizontal beam angle and a vertical beam angle, or a range of horizontal and/or vertical beam angles in which the Tx beams are transmitted (e.g., a −60 degrees to +60 degrees range of horizontal beam angles, and a −1- degrees to +10 degrees range of vertical beam angles).

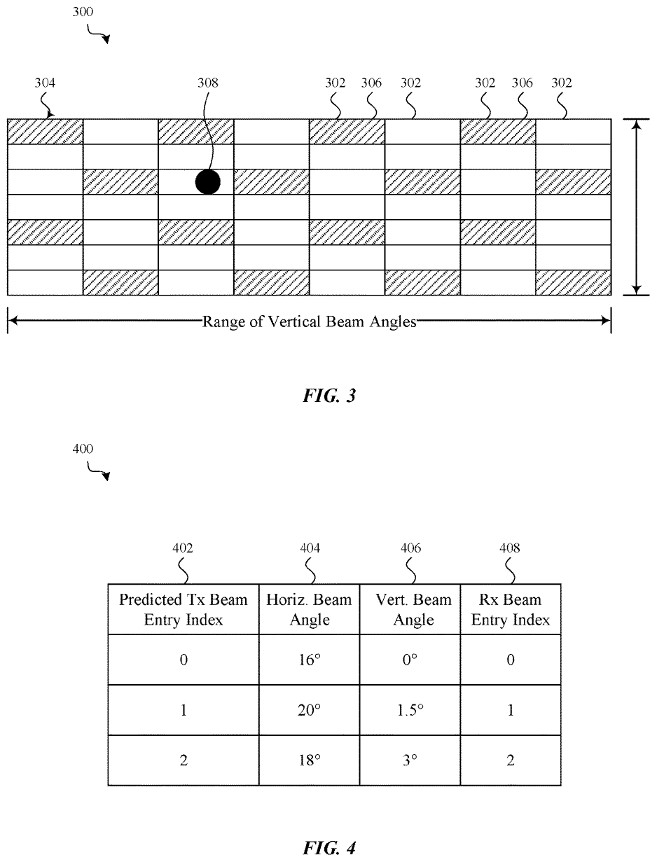

As an example, FIG. 3 shows a Tx beam Set A 300 including fifty-six Tx beams 302, with a Tx beam Set B 304 including sixteen Tx beams 306 identified within the Tx beams 302 of the Tx beam Set A 300. The Tx beams 306 in Tx beam Set B 304 may be selected by the network device such that, if the network device transmits reference signals on only the Tx beams 306 of Tx beam Set B 304 (or similarly, if the UE only measures reference signals received on the Tx beams 306 of Tx beam Set B 304), the UE may be able to predict whether other Tx beams 302 of the Tx beam Set A 300 (or narrower Tx beams (e.g., Tx beam 308) within or near the range of horizontal and/or vertical beam angles spanned by the Tx beams 302 of Tx beam Set A 300). Although all possible Tx beams, narrow or otherwise, could be assigned a beam ID and be identified as a Tx beam 302 of Tx beam Set A 300, there are many possible Tx beams and the overhead of identifying all such Tx beams may be impractical and use too many network or UE resources.

At 206, the method 200 may include generating a set of measurements based on a set of reference signals. The set of reference signals may be received via the transceiver and from the network device, on at least one beam of the set of Tx beams indicated at 204 (e.g., on at least one or all of the Tx beams in Tx beams Set B). In typical embodiments, multiple reference signals may be received on multiple Tx beams. In some embodiments, the reference signals may include CSI-RS transmitted on configured CSI-RS resources. In some embodiments, the set of measurements may include RSRP or SINR measurements.

At 208, the method 200 may include determining, at least partly based on the set of measurements and using AI, a set of predicted Tx beams that is best received by the UE. In some embodiments, the set of measurements generated at 206 may be provided as inputs to an AI model, and the predicted Tx beams may be provided as an output of the AI model. The predicted Tx beams may include one or multiple Tx beams. The Tx beam(s) that are best received by the UE may be Tx beams having a predicted (or measured) highest RSRP, highest SINR, or other parameter. The set of predicted Tx beams may include one or more Tx beams inside or outside the set of Tx beams indicated at 204. For example, a predicted Tx beam may be one of the Tx beams indicated at 204 (e.g., one of the Tx beams in Tx beams Set B or one of the Tx beams in Tx beams Set A), or a predicted Tx beam may be a Tx beam other than one of the Tx beams indicated at 204 (e.g., a narrower Tx beam and/or a Tx beam having a horizontal and/or vertical beam angle that is interpolated or extrapolated from other beam angles (e.g., from beam angles of the at least one beam on which the reference signal(s) are received at 206).

At 210, the method 200 may include transmitting, via the transceiver (and in some cases to the network device), a report identifying the set of predicted Tx beams (e.g., a beam management report or CSI report carrying predicted Tx beam information). In some embodiments, the report may identify one or more, or each, Tx beam in the set of predicted Tx beams by at least one beam angle (e.g., by a horizontal beam angle and a vertical beam angle). In some embodiments, the report may identify one or more, or each, Tx beam in the set of predicted Tx beams by a beam ID. However, in many cases, a predicted Tx beam may not be associated with a beam ID (e.g., because the AI may predict Tx beams from a much larger array of Tx beams than the network device can, or should, practically assign beam IDs.).

At 212, the method 200 may optionally include receiving, via the transceiver (and in some cases from the network device), an indication that a second set of reference signals will be transmitted on at least one predicted Tx beam identified in the report transmitted at 210.

At 214, the method 200 may optionally include generating a second set of measurements based on a second set of reference signals, received via the transceiver and from the network device. The second set of reference signals may be received on at least one Tx beam of the set of predicted Tx beams. In typical embodiments, multiple reference signals may be received on multiple Tx beams.

At 216, the method 200 may optionally include transmitting, via the transceiver (and in some cases to the network device), a report based at least in part on the second set of measurements. In some embodiments, the report may include one or more preferred Tx beams of the UE (e.g., one or more preferred Tx beams from among the Tx beams on which the second set of reference signals is received). The report may also or alternatively include one or more measurements (e.g., RSRP or SINR measurements) in the second set of measurements.

At 218, the method 200 may optionally include receiving, via the transceiver (and in some cases from the network device), an indication of at least one Tx beam for receiving a data channel (e.g., a PDSCH) or a control channel (e.g., a PDCCH).

The method 200 may be variously embodied, extended, or adapted, as described in the following paragraphs and elsewhere in this description. Although the operations described at 202-218 may be performed in the order shown, the operations may in some cases be performed in different orders.

The network device referenced in operations 202-206 and 210-218 may in some cases be a network device of a RAN (e.g., a gNB). Although the method 200 is described in terms of the UE communicating with a singular network device, the UE could alternatively communicate with more than one network device (e.g., the set of UE capabilities may be transmitted to a first network device, and the reference signals may be received on Tx beams of a second network device).

In some embodiments, the method 200 may be performed for the purpose of Tx beam tracking, and the network device may assume that the reports transmitted at 210 and 216 are for a single Rx beam of the UE. In some embodiments, the method 200 may be performed for the purpose of Tx beam and Rx beam tracking, and the UE may indicate the Rx beam(s) to which the predicted Tx beams reported at 210, or preferred Tx beams or measurements reported at 216, correspond. For example, the report transmitted at 210 may associate each predicted Tx beam in the set of predicted Tx beams with a corresponding Rx beam of the UE (e.g., the report may identify a set of predicted Rx/Tx beam pairs, such as “Rx beam 1 and Tx beam 4”, or “Rx beam 3 and Tx beam 2”, or “Rx beam angles p and q and Tx beam angles x and y”), and the UE and network device may both maintain this information going forward. In some embodiments, the UE may transmit different reports for different Rx beams—e.g., a report identifying a set of predicted Tx beams may be associated with a particular Rx beam. In some embodiments, the UE may transmit a report that identifies different Rx beams for the different predicted Tx beams identified in the report.

When the UE identifies, to the network device, a set of predicted Rx/Tx beam pairs, the network device may need to indicate, at 212, the Rx beams that the UE should use to receive the second set of reference signals on the indicated Tx beam(s). Or, if a predicted Tx beam is only associated with one Rx beam of the UE, the Rx beam may be inferred by the UE.

In some embodiments of the method 200, the predicted Tx beams and/or Rx beams may be indicated, at 212 or 218, by means of a beam ID, or by horizontal and vertical beam angles, or in other ways.

In some embodiments of the method 200, the network device may not need to allocate dedicated CSI-RS resources for a UE at 212 or 218. For example, for the operations at 214 or 218, the network device may indicate to a UE (e.g., by RRC signaling or a MAC CE) that the measurement resources (e.g., measurement resources for beam management, such as CSI-RS resources) are aligned with the predicted Tx beams (and when applicable, Rx beams) reported at 210 (e.g., the measurement resources are allocated for, and the reference signals are transmitted on, one or more of the predicted Tx beams reported at 210 or one or more Tx beams that share a TCI state or QCL property with the one or more of the predicted Tx beams). Alternatively, a 3GPP technical specification (TS) may specify that the UE should assume the measurement resources for the operations at 214 or 218 are aligned (or QCL'd) with the predicted Tx beams (and when applicable, Rx beams) reported at 210.

In some embodiments of the method 200, the UE may identify two or more predicted Tx beams in a single report, or the UE may identify different predicted Tx beams in two or more reports. The reports may be generated as a result of performing the method 200 one or multiple (e.g., two or more) times. The network device may therefore need a means by which it can indicate that it has accepted a recommendation of the UE and is transmitting, to the UE, on one or more of the UE's predicted Tx beams. When the network device indicates that it is transmitting on a predicted Tx beam identified in a particular report, and the particular report identifies more than one predicted Tx beam, the network device may need to identify the predicted Tx beam by “report” and “predicted Tx beam entry within the report”. That is, the network device may have to indicate its selection of a predicted Tx beam or predicted Tx beams within a report. Alternatively, a technical specification, configuration, or signaling can be used to indicate a default Tx beam selection (e.g., if a particular report identifies more than one predicted Tx beam, a technical specification, configuration, or signaling could indicate that the predicted Tx beam identified by the first entry in the report is presumed to be the predicted Tx beam that the network device will be using). In some embodiments, the UE may format a report that identifies multiple predicted Tx beams such that a preferred predicted Tx beam (e.g., a predicted Tx beam associated with a highest RSRP or SINR) may occupy a particular position within a report, such as the first entry within a report.

By way of example, FIG. 4 shows an example of a report 400 that may be transmitted at 210. The report 400 includes, for each of a number of predicted Tx beams, a predicted Tx beam entry index 402 (e.g., 0, 1, 2, etc.), a horizontal (Horiz.) beam angle 404 of a predicted Tx beam, a vertical (Vert.) beam angle 406 of a predicted Tx beam, and, optionally, a Rx beam to which the predicted Tx beam corresponds (e.g., a Rx beam entry index 408). In some cases, the Rx beam information need not be transmitted and, upon receiving an indication of a particular predicted Tx beam from the network device, the UE may locally determine the Rx beam associated with the predicted Tx beam.

In some embodiments, the method 200 may include tracking the receive time of each uplink control information (UCI) that carries a report of predicted Tx beams (e.g., the times that the network device receives particular reports). In these embodiments, the indication received at 212 (i.e., the indication that the second set of reference signals will be transmitted on at least one predicted Tx beam identified in the report transmitted at 210) or the indication received at 218 may include an indication of a receive time of an UCI carrying the report in which the predicted Tx beam was identified (e.g., the UCI carrying the report transmitted at 210, or the UCI that carried a particular report at 210 or another time). When the UCI is transmitted or carried in a physical uplink shared channel (PUSCH), the method 200 may include determining (e.g., deducing) the receive time of the UCI from an acknowledgment (ACK) indication for the PUSCH. Determining the receive time in this manner (both at the UE and at the network device) can avoid any misunderstanding if there are retransmissions of the UCI. Alternatively, and when the UCI is transmitted or carried in a PUSCH, the method 200 may include determining the receive time of the UCI from a receive time of the PUSCH. When the UCI is transmitted or carried in a physical uplink control channel (PUCCH), the method 200 may include determining the receive time of the UCI from a would-be PUCCH receive time before UCI multiplexing over PUCCH or PUSCH. In the latter case, and by way of example, the receive time of UCI that was supposed to be transmitted in symbol 1 of slot 100, but was ultimately transmitted in symbol 10 of slot 100 due to the application of multiplexing rules, would be symbol 1 of slot 100.

In some embodiments of the method 200, the indication received at 212 (i.e., the indication that the second set of reference signals will be transmitted on at least one predicted Tx beam identified in the report transmitted at 210) or the indication received at 218 may include an indication of a receive time of an UCI carrying the report in which the predicted Tx beam was identified (e.g., the UCI carrying the report transmitted at 210, or the UCI that carried a particular report at 210 or another time). The UE may use the receive time as an index into its saved mapping of UCI receive times to predicted Tx beams (or predicted Rx/Tx beam pairs).

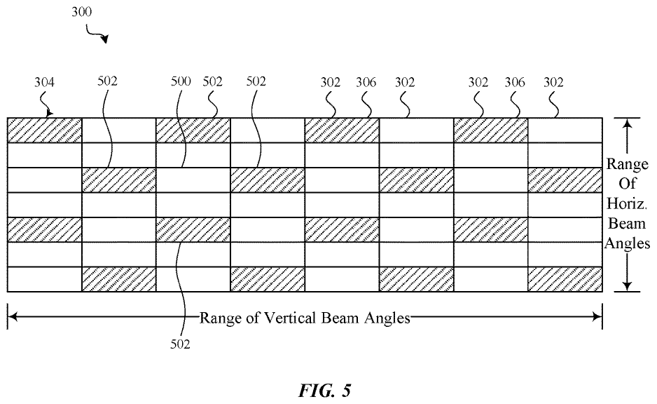

In some embodiments, a reference signal received at 214 may be received on a predicted Tx beam of the set of predicted Tx beams, and the method 200 may include determining a QCL property of the reference signal (or a QCL property of a TCI state that applies to the reference signal, or to another signal that shares a QCL property with the reference signal). In some embodiments, the QCL property may be determined based at least in part on a set of QCL properties of one or more reference signals received on one or more neighbor Tx beams of the predicted Tx beam. As an example, FIG. 5 shows the Tx beam Set A 300 and Tx beam Set B 304 that were introduced in FIG. 3, and shows a predicted Tx beam 500 on which a reference signal may be received at 214 of the method 200. The predicted Tx beam 500 may have neighbor Tx beams 502 that are Tx beams 306 of the Tx beam Set B 304. In some embodiments, a QCL property of the reference signal received on the predicted Tx beam 500 may be determined from the QCL properties of reference signals received on the neighbor Tx beams 502. In some cases, the QCL property of the reference signal received on the predicted Tx beam 500 may be determined using a function (e.g., an interpolation function or an extrapolation function) identified in a technical specification (e.g., in a 3GPP technical specification). In some cases, the QCL property of the reference signal received on the predicted Tx beam 500 may be determined using a UE-specific function (e.g., an interpolation or extrapolation function programmed by a UE manufacturer or UE vendor). In some cases, a function identified in a technical specification or a UE-specific function may be used to determine a single QCL property (e.g., Doppler shift, Doppler spread, average delay, delay spread, or spatial Rx filtering). In some cases, a function identified in a technical specification or a UE-specific function may be used to determine multiple QCL properties (e.g., two or more or all QCL properties). A function for determining a QCL property of a reference signal received on a predicted Tx beam may, in some cases, assume that the channel properties of different Tx beams follow a continuous function.

In some embodiments of the method 200, a QCL property of a reference signal received on a predicted Tx beam at 214 may be determined from a TCI state for the reference signal. For example, a new TCI state may be used to induce or deduce one or more QCL properties from one or more signals received on neighbor Tx beams. In some embodiments, and by way of example, the new TCI state may be used to determine a QCL property for spatial Rx filtering only, or for spatial Rx filtering and one or more other QCL properties, or for one or a subset of QCL properties other than spatial Rx filtering.

In some embodiments of the method 200, the indication received at 204 and/or another indication may indicate the horizontal and/or vertical beam angles of one or more of the network device's Tx beams. For example, the indication may indicate 1) the horizontal and/or vertical beam angles associated with each of the Tx beams in the Tx beam Set B, or 2) the range of horizontal and/or vertical beam angles spanned by the Tx beam Set A. In addition, one or more of the indication at 204, a function used to determine a QCL property of a reference signal received on a predicted Tx beam, and/or a technical specification, configuration, or signaling may indicate a range of horizontal beam angles and/or a range of vertical beam angles that can be used, by the UE, to identify one or more neighbor Tx beams for a predicted Tx beam.

In some embodiments, a data channel, control channel, or reference signal received at 218 may be received on a predicted Tx beam of the set of predicted Tx beams, and the method 200 may include determining a QCL property of the reference signal (or a QCL property of a TCI state that applies to the reference signal, or to another signal that shares a QCL property with the reference signal) similarly to how a QCL property may be determined for a reference signal received at 214.

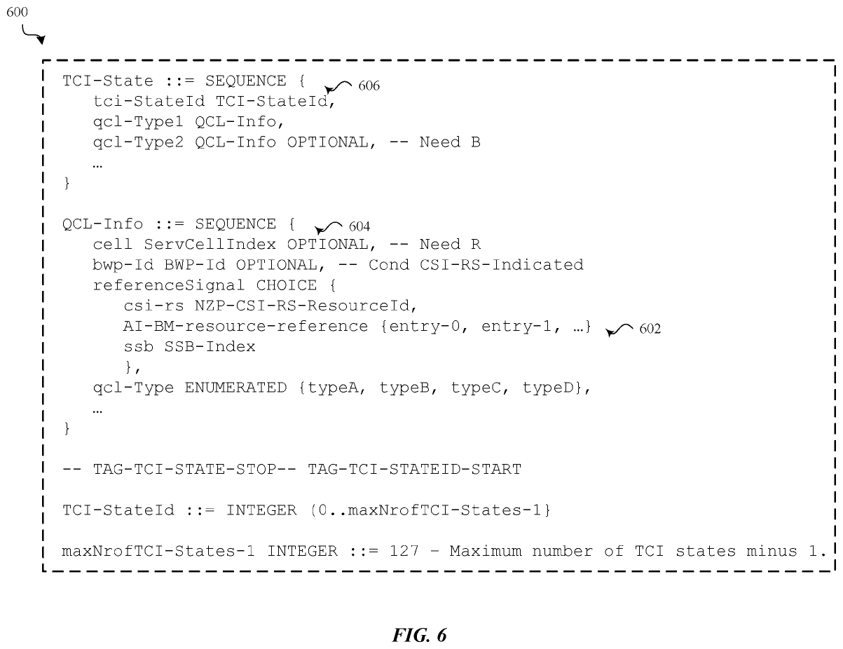

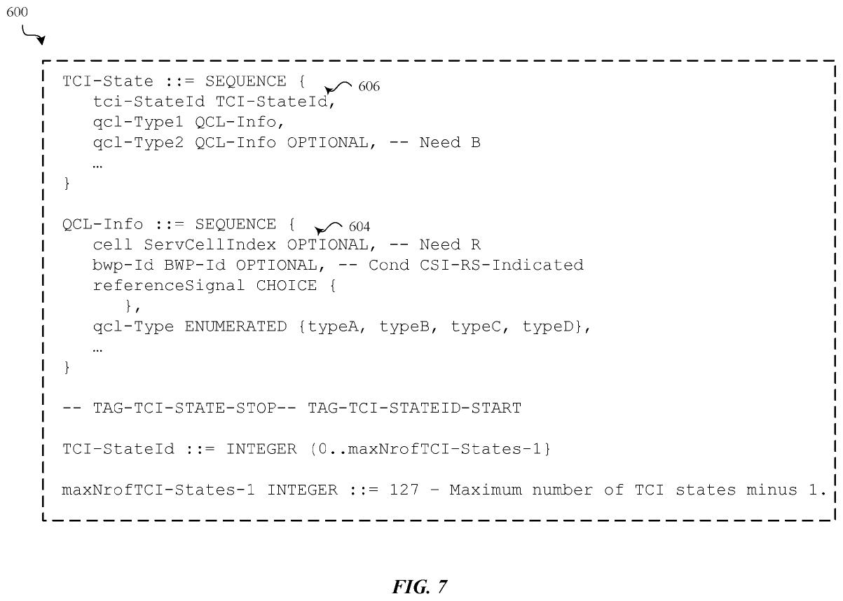

In some embodiments of the method 200, the indication of the set of Tx beams of the network device, received at 204, may include a first indication of a first set of Tx beams on which the network device is configured to transmit (e.g., a Tx beam Set A), and a second indication of a second set of Tx beams. The second set of Tx beams may be a subset of the first set of Tx beams (e.g., a Tx beam Set B). In some embodiments, the indication received at 204 may include a third indication of a third set of Tx beams and/or additional indications of additional sets of Tx beams. In some embodiments, the second, third and optional additional indications of additional sets of Tx beams may correspond to different subsets of Tx beams in the Tx beam Set A. For example, the second, third and optional additional indications of additional sets of Tx beams may respectively correspond to a Tx beam Set B-0, a Tx beam Set B-1, and so on. Regardless of whether there is one or multiple Tx beam Set B(s), the Tx beams of each Tx beam Set B may be associated with (e.g., mapped to) one or more QCL properties (i.e., QCL information). In some embodiments, this mapping may be performed by associating the Tx beams with a TCI state. For example, FIG. 6 shows an example mapping 600 of Tx beams 602 in a Tx beam Set B to QCL information 604 associated with a TCI state 606. The Tx beams 602 are identified as “entry-0”, “entry-1”, and so on. In cases where there are multiple Tx beam Set Bs configured, the Tx beams 602 may be identified by their Tx beam Set B and entry within the Tx beam Set B (e.g., “Set-B-0, entry 0”, “Set-B-0, entry 1”, Set-B-1, entry 0”, and so on). In these examples, Tx beams of a Tx beam Set B are indicated within a definition of a TCI state. Alternatively, and by way of further example, excessive RRC signaling may be avoided by mapping QCL information 604 such as a cell identifier (cell-ID), a bandwidth part identifier (BWP-ID), and a QCL type (e.g., QCL-TypeA, QCL-TypeB, QCL-TypeC, or QCL-TypeD) to a TCI state 606, as shown in FIG. 7, but using a formula to map the QCL information 604 or TCI state 606 shown in FIG. 7 to a MAC CE or downlink control information (DCI) field design that lists the Tx beams of the Tx beam Set B(s) to which the QCL information or TCI state applies. In these latter examples, Tx beams of a Tx beam Set B are indicated in a MAC CE or DCI that is linked to a TCI state.

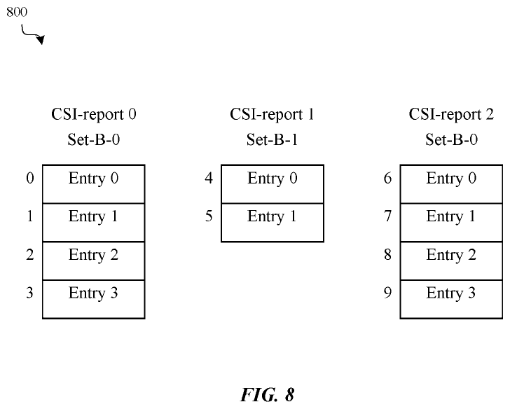

In some embodiments of the method 200, multiple reports that identify predicted Tx beams may be transmitted at 210. Each report may include one or multiple predicted Tx beam entries. By way of example, FIG. 8 shows three reports 800 (CSI-report 0, CSI-report 1, CSI-report 2) that may be transmitted at the same time (e.g., in the same slot). By way of further example, the first report (CSI-report 0) includes four predicted Tx beam entries (Entry 0, Entry 1, Entry 2, and Entry 3) for a Tx beam Set B-0; the second report (CSI-report 1) includes two predicted Tx beam entries (Entry 0, Entry 1) for a Tx beam Set B-1; and the third report (CSI-report 2) includes four predicted Tx beam entries (Entry 0, Entry 1, Entry 2, and Entry 3) for a Tx beam Set B-0.

In some cases, and still referring to FIG. 8, the entries associated with different reports, transmitted at the same time, may be indexed consecutively across the different reports, as shown in FIG. 8. For example, Entries 0-3 of CSI-report 0 may be indexed 0-3 respectively; Entries 0 and 1 of CSI-report 1 may be indexed 4 and 5 respectively; and Entries 0-3 of CSI-report 2 may be indexed 6-9 respectively. In these cases, the bit-width of a predicted Tx beam entry is determined by the total number of entries in all reports. Alternatively, and in some cases, a network device may only index predicted Tx beam entries in one report for each Tx beam Set B. Thus, in the example shown in FIG. 8, the network device may index only one of CSI-report 0 or CSI-report 2, in addition to CSI-report 1. The network device's selection of CSI-report 0 or CSI-report 2 may be dictated by, for example, which report is transmitted first, which report is transmitted last, or which report is associated with the highest CSI priority (e.g., from 3GPP TS 38.214). This reduces the bit-width of a predicted Tx beam entry from four bits (needed to address 9 entries (i.e., 4+2+4) to three bits (needed to address 6 entries (i.e., 4+2)). Alternatively, and in some cases, it may be agreed-by technical specification, configuration, or signaling that a network device will only use a particular predicted Tx beam entry for each Tx beam Set B. For example, it may be agreed that a network device will only use the first entry (or last entry, or some other entry) among all entries in all reports for each Tx beam Set B. Thus, in the example shown in FIG. 8, the network device will only use Entry 0 of CSI-report 0 and Entry 0 of CSI-report 1. This reduces the bit-width of a predicted Tx beam entry to one bit (i.e., 1+1 for the two Tx beam Set Bs).

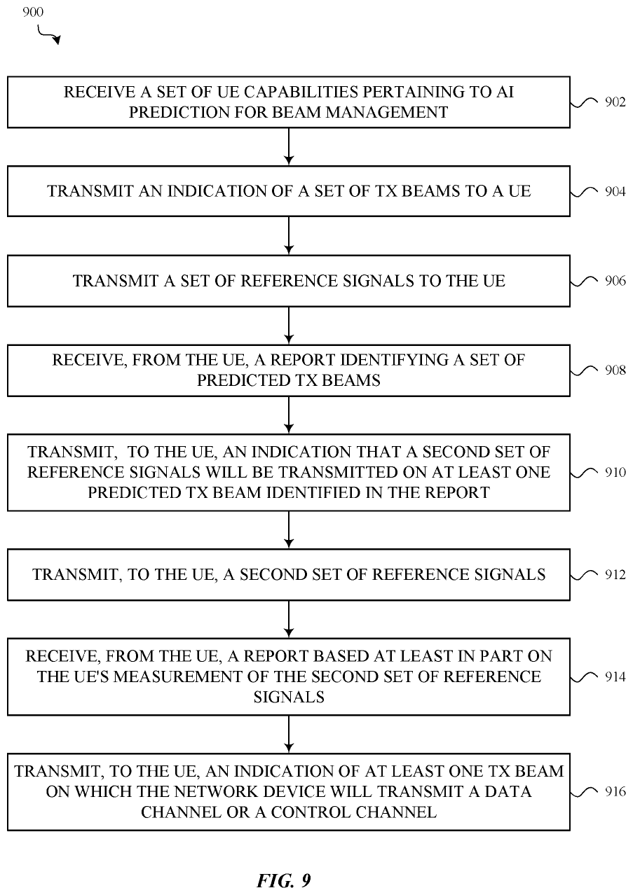

FIG. 9 shows an example method 900 of wireless communication by a network device (e.g., a network device of a RAN, such as a gNB). In some cases, the network device may be one of the network devices described with reference to FIG. 1 or one of the other network devices described herein. The method 900 may be performed using a transceiver (or radio), a processor, or other components of the network device.

At 902, the method 900 may optionally include receiving, via the transceiver and from a UE, a set of UE capabilities pertaining to AI prediction for beam management. The set of UE capabilities may indicate, for example, whether the UE is configured to make an AI prediction for beam management; the inputs that the UE's AI prediction model needs or can use; the outputs that the UE's AI prediction model produces; and so on. The set of UE capabilities may be received, for example, in RRC signaling or in one or more MAC CEs.

At 904, the method 900 may include transmitting, via the transceiver, an indication of a set of Tx beams of the network device. In some embodiments, the indication of the set of Tx beams may include a first indication of a first set of Tx beams (e.g., a Tx beam Set A) on which the network device is configured to transmit. The Tx beams in the first set of Tx beams may be Tx beams to which the network device has assigned beam IDs. In some embodiments, the indication of the set of Tx beams may also or alternatively include a second indication of a second set of Tx beams (e.g., a Tx beam Set B) on which the network device is or will be transmitting reference signals (e.g., CSI-RS) that the UE can measure for purposes of beam management or other purposes.

At 906, the method 900 may include transmitting a set of reference signals via the transceiver. The set of reference signals may be transmitted on at least one beam of the set of Tx beams indicated at 904 (e.g., on at least one or all of the Tx beams in Tx beams Set B). In typical embodiments, multiple reference signals may be transmitted on multiple Tx beams. In some embodiments, the reference signals may include CSI-RS transmitted on configured CSI-RS resources.

At 908, the method 900 may include receiving, via the transceiver, a report identifying a set of predicted Tx beams (e.g., a beam management report or CSI report carrying predicted Tx beam information). The set of predicted Tx beams may include one or more Tx beams inside or outside the set of Tx beams indicated at 904. In some embodiments, the report may identify one or more, or each, Tx beam in the set of predicted Tx beams by at least one beam angle (e.g., by a horizontal beam angle and a vertical beam angle). In some embodiments, the report may identify one or more, or each, Tx beam in the set of predicted Tx beams by a beam ID. However, in many cases, a predicted Tx beam may not be associated with a beam ID.

At 910, the method 900 may optionally include transmitting, via the transceiver and to the UE, an indication that a second set of reference signals will be transmitted on at least one predicted Tx beam identified in the report received at 908.

At 912, the method 900 may optionally include transmitting, via the transceiver and to the UE, a second set of reference signals. The second set of reference signals may be transmitted on at least one Tx beam of the set of predicted Tx beams. In typical embodiments, multiple reference signals may be transmitted on multiple Tx beams.

At 914, the method 900 may optionally include receiving, via the transceiver and from the UE, a report based at least in part on the UE's measurement of the second set of reference signals. In some embodiments, the report may include one or more preferred Tx beams of the UE (e.g., one or more preferred Tx beams from among the Tx beams on which the second set of reference signals is received). The report may also or alternatively include one or more measurements (e.g., RSRP or SINR measurements).

At 916, the method 900 may optionally include transmitting, via the transceiver and to the UE, an indication of at least one Tx beam on which the network device will transmit a data channel (e.g., a PDSCH) or a control channel (e.g., a PDCCH).

The method 900 may be variously embodied, extended, or adapted, as described, for example, with reference to FIG. 2 and elsewhere in this description. Although the operations described at 902-916 may be performed in the order shown, the operations may in some cases be performed in different orders.

Embodiments contemplated herein include one or more non-transitory computer-readable media storing instructions to cause an electronic device, upon execution of the instructions by one or more processors of the electronic device, to perform one or more elements of the method 200 or 900. In the context of method 200, this non-transitory computer-readable media may be, for example, a memory of a UE (such as a memory 1106 of a wireless device 1102 that is a UE, as described herein). In the context of method 900, this non-transitory computer-readable media may be, for example, a memory of a network device (such as a memory 1124 of a network device 1120, as described herein).

Embodiments contemplated herein include an apparatus having logic, modules, or circuitry to perform one or more elements of the method 200 or 900. In the context of method 200, this apparatus may be, for example, an apparatus of a UE (such as a wireless device 1102 that is a UE, as described herein). In the context of method 900, this apparatus may be, for example, an apparatus of a network device (such as a network device 1120, as described herein).

Embodiments contemplated herein include an apparatus having one or more processors and one or more computer-readable media, using or storing instructions that, when executed by the one or more processors, cause the one or more processors to perform one or more elements of the method 200 or 900. In the context of method 200, this apparatus may be, for example, an apparatus of a UE (such as a wireless device 1102 that is a UE, as described herein). In the context of the method 900, this apparatus may be, for example, an apparatus of a network device (such as a network device 1120, as described herein).

Embodiments contemplated herein include a signal as described in or related to one or more elements of the method 200 or 900.

Embodiments contemplated herein include a computer program or computer program product having instructions, wherein execution of the program by a processor causes the processor to carry out one or more elements of the method 200 or 900. In the context of method 200, the processor may be a processor of a UE (such as a processor(s) 1104 of a wireless device 1102 that is a UE, as described herein), and the instructions may be, for example, located in the processor and/or on a memory of the UE (such as a memory 1106 of a wireless device 1102 that is a UE, as described herein). In the context of method 900, the processor may be a processor of a network device (such as a processor(s) 1122 of a network device 1120, as described herein), and the instructions may be, for example, located in the processor and/or on a memory of the network device (such as a memory 1124 of a network device 1120, as described herein).

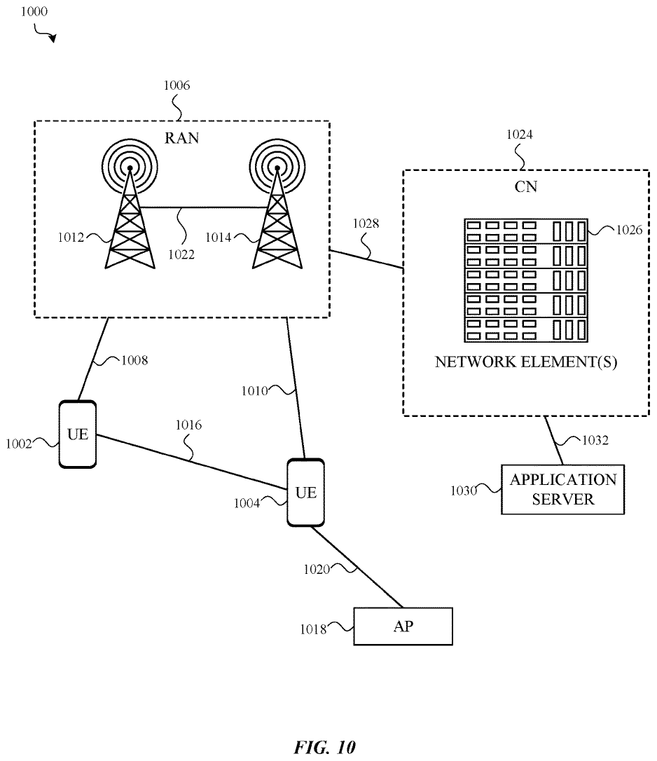

FIG. 10 illustrates an example architecture of a wireless communication system, according to embodiments described herein. The following description is provided for an example wireless communication system 1000 that operates in conjunction with the LTE system standards or specifications and/or 5G or NR system standards or specifications, as provided by 3GPP technical specifications.

As shown by FIG. 10, the wireless communication system 1000 includes UE 1002 and UE 1004 (although any number of UEs may be used). In this example, the UE 1002 and the UE 1004 are illustrated as smartphones (e.g., handheld touchscreen mobile computing devices connectable to one or more cellular networks), but may also comprise any mobile or non-mobile computing device configured for wireless communication.

The UE 1002 and UE 1004 may be configured to communicatively couple with a RAN 1006. In embodiments, the RAN 1006 may be NG-RAN, E-UTRAN, etc. The UE 1002 and UE 1004 utilize connections (or channels) (shown as connection 1008 and connection 1010, respectively) with the RAN 1006, each of which comprises a physical communications interface. The RAN 1006 can include one or more network devices, such as base station 1012 and base station 1014, that enable the connection 1008 and connection 1010.

In this example, the connection 1008 and connection 1010 are air interfaces to enable such communicative coupling, and may be consistent with RAT(s) used by the RAN 1006, such as, for example, an LTE and/or NR.

In some embodiments, the UE 1002 and UE 1004 may also directly exchange communication data via a sidelink interface 1016. The UE 1004 is shown to be configured to access an access point (shown as AP 1018) via connection 1020. By way of example, the connection 1020 can comprise a local wireless connection, such as a connection consistent with any IEEE 802.11 protocol, wherein the AP 1018 may comprise a Wi-Fi® router. In this example, the AP 1018 may be connected to another network (for example, the Internet) without going through a CN 1024.

In embodiments, the UE 1002 and UE 1004 can be configured to communicate using orthogonal frequency division multiplexing (OFDM) communication signals with each other or with the base station 1012 and/or the base station 1014 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1012 or base station 1014 may be implemented as one or more software entities running on server computers as part of a virtual network. In addition, or in other embodiments, the base station 1012 or base station 1014 may be configured to communicate with one another via interface 1022. In embodiments where the wireless communication system 1000 is an LTE system (e.g., when the CN 1024 is an EPC), the interface 1022 may be an X2 interface. The X2 interface may be defined between two or more network devices of a RAN (e.g., two or more eNBs and the like) that connect to an EPC, and/or between two eNBs connecting to the EPC. In embodiments where the wireless communication system 1000 is an NR system (e.g., when CN 1024 is a 5GC), the interface 1022 may be an Xn interface. The Xn interface is defined between two or more network devices of a RAN (e.g., two or more gNBs and the like) that connect to the 5GC, between a base station 1012 (e.g., a gNB) connecting to the 5GC and an eNB, and/or between two eNBs connecting to the 5GC (e.g., CN 1024).

The RAN 1006 is shown to be communicatively coupled to the CN 1024. The CN 1024 may comprise one or more network elements 1026, which are configured to offer various data and telecommunications services to customers/subscribers (e.g., users of UE 1002 and UE 1004) who are connected to the CN 1024 via the RAN 1006. The components of the CN 1024 may be implemented in one physical device or separate physical devices including components to read and execute instructions from a machine-readable or computer-readable medium (e.g., a non-transitory machine-readable storage medium).

In embodiments, the CN 1024 may be an EPC, and the RAN 1006 may be connected with the CN 1024 via an S1 interface 1028. In embodiments, the S1 interface 1028 may be split into two parts, an S1 user plane (S1-U) interface, which carries traffic data between the base station 1012 or base station 1014 and a serving gateway (S-GW), and the S1-MME interface, which is a signaling interface between the base station 1012 or base station 1014 and mobility management entities (MMEs).

In embodiments, the CN 1024 may be a 5GC, and the RAN 1006 may be connected with the CN 1024 via an NG interface 1028. In embodiments, the NG interface 1028 may be split into two parts, an NG user plane (NG-U) interface, which carries traffic data between the base station 1012 or base station 1014 and a user plane function (UPF), and the S1 control plane (NG-C) interface, which is a signaling interface between the base station 1012 or base station 1014 and access and mobility management functions (AMFs).

Generally, an application server 1030 may be an element offering applications that use internet protocol (IP) bearer resources with the CN 1024 (e.g., packet switched data services). The application server 1030 can also be configured to support one or more communication services (e.g., VoIP sessions, group communication sessions, etc.) for the UE 1002 and UE 1004 via the CN 1024. The application server 1030 may communicate with the CN 1024 through an IP communications interface 1032.

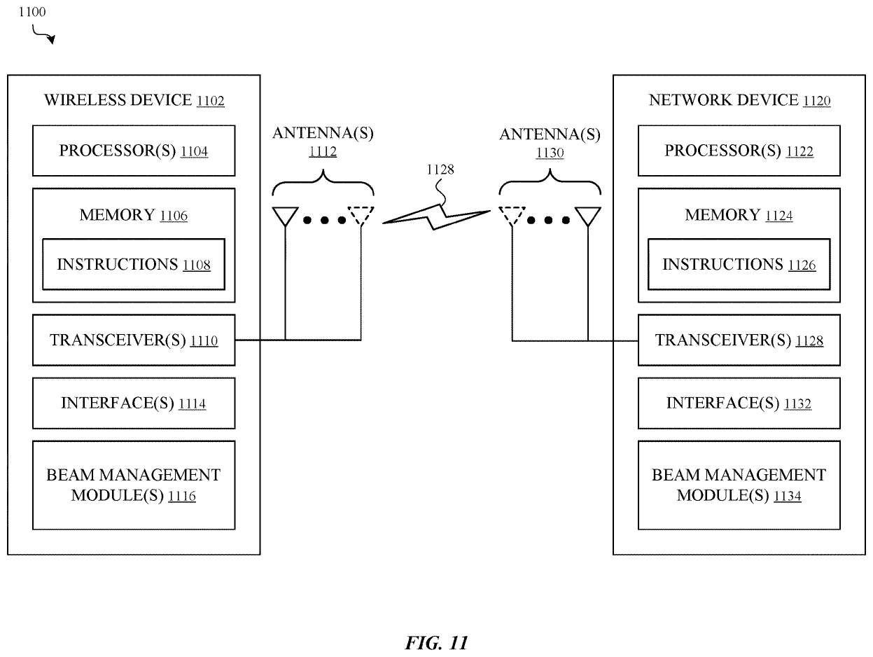

FIG. 11 illustrates an example system 1100 for performing signaling 1138 between a wireless device 1102 and a network device 1120, according to embodiments described herein. The system 1100 may be a portion of a wireless communication system as herein described. The wireless device 1102 may be, for example, a UE of a wireless communication system. The network device 1120 may be, for example, a base station (e.g., an eNB or a gNB) or a radio head of a wireless communication system.

The wireless device 1102 may include one or more processor(s) 1104. The processor(s) 1104 may execute instructions such that various operations of the wireless device 1102 are performed, as described herein. The processor(s) 1104 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1102 may include a memory 1106. The memory 1106 may be a non-transitory computer-readable storage medium that stores instructions 1108 (which may include, for example, the instructions being executed by the processor(s) 1104). The instructions 1108 may also be referred to as program code or a computer program. The memory 1106 may also store data used by, and results computed by, the processor(s) 1104.

The wireless device 1102 may include one or more transceiver(s) 1110 (also collectively referred to as a transceiver 1110) that may include radio frequency (RF) transmitter and/or receiver circuitry that use the antenna(s) 1112 of the wireless device 1102 to facilitate signaling (e.g., the signaling 1138) to and/or from the wireless device 1102 with other devices (e.g., the network device 1120) according to corresponding RATs.

The wireless device 1102 may include one or more antenna(s) 1112 (e.g., one, two, four, eight, or more). For embodiments with multiple antenna(s) 1112, the wireless device 1102 may leverage the spatial diversity of such multiple antenna(s) 1112 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 1102 may be accomplished according to precoding (or digital beamforming) that is applied at the wireless device 1102 that multiplexes the data streams across the antenna(s) 1112 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In some embodiments having multiple antennas, the wireless device 1102 may implement analog beamforming techniques, whereby phases of the signals sent by the antenna(s) 1112 are relatively adjusted such that the (joint) transmission of the antenna(s) 1112 can be directed (this is sometimes referred to as beam steering).

The wireless device 1102 may include one or more interface(s) 1114. The interface(s) 1114 may be used to provide input to or output from the wireless device 1102. For example, a wireless device 1102 that is a UE may include interface(s) 1114 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1110/antenna(s) 1112 already described) that allow for communication between the UE and other devices and may operate according to known protocols (e.g., Wi-Fi®, Bluetooth®, and the like).

The wireless device 1102 may include beam management module(s) 1116. The beam management module(s) 1116 may be implemented via hardware, software, or combinations thereof. For example, the beam management module(s) 1116 may be implemented as a processor, circuit, and/or instructions 1108 stored in the memory 1106 and executed by the processor(s) 1104. In some examples, the beam management module(s) 1116 may be integrated within the processor(s) 1104 and/or the transceiver(s) 1110. For example, the beam management module(s) 1116 may be implemented by a combination of software components (e.g., executed by a DSP or a general processor) and hardware components (e.g., logic gates and circuitry) within the processor(s) 1104 or the transceiver(s) 1110.

The beam management module(s) 1116 may be used for various aspects of the present disclosure, for example, aspects of FIGS. 1-9, from a wireless device or UE perspective. The beam management module(s) 1116 may be configured to, for example, measure reference signals received from a network device, transmit reports of predicted Tx beams to the network device, and determine QCL information for signals received from the network device (e.g., the network device 1120).

The network device 1120 may include one or more processor(s) 1122. The processor(s) 1122 may execute instructions such that various operations of the network device 1120 are performed, as described herein. The processor(s) 1122 may include one or more baseband processors implemented using, for example, a CPU, a DSP, an ASIC, a controller, an FPGA device, another hardware device, a firmware device, or any combination thereof configured to perform the operations described herein.

The network device 1120 may include a memory 1124. The memory 1124 may be a non-transitory computer-readable storage medium that stores instructions 1126 (which may include, for example, the instructions being executed by the processor(s) 1122). The instructions 1126 may also be referred to as program code or a computer program. The memory 1124 may also store data used by, and results computed by, the processor(s) 1122.

The network device 1120 may include one or more transceiver(s) 1128 (also collectively referred to as a transceiver 1128) that may include RF transmitter and/or receiver circuitry that use the antenna(s) 1130 of the network device 1120 to facilitate signaling (e.g., the signaling 1138) to and/or from the network device 1120 with other devices (e.g., the wireless device 1102) according to corresponding RATs.

The network device 1120 may include one or more antenna(s) 1130 (e.g., one, two, four, or more). In embodiments having multiple antenna(s) 1130, the network device 1120 may perform MIMO, digital beamforming, analog beamforming, beam steering, etc., as has been described.

The network device 1120 may include one or more interface(s) 1132. The interface(s) 1132 may be used to provide input to or output from the network device 1120. For example, a network device 1120 of a RAN (e.g., a base station, a radio head, etc.) may include interface(s) 1132 made up of transmitters, receivers, and other circuitry (e.g., other than the transceiver(s) 1128/antenna(s) 1130 already described) that enables the network device 1120 to communicate with other equipment in a network, and/or that enables the network device 1120 to communicate with external networks, computers, databases, and the like for purposes of operations, administration, and maintenance of the network device 1120 or other equipment operably connected thereto.

The network device 1120 may include one or more beam management module(s) 1134. The beam management module(s) 1134 may be implemented via hardware, software, or combinations thereof. For example, the beam management module(s) 1134 may be implemented as a processor, circuit, and/or instructions 1126 stored in the memory 1124 and executed by the processor(s) 1122. In some examples, the beam management module(s) 1134 may be integrated within the processor(s) 1122 and/or the transceiver(s) 1128. For example, the beam management module(s) 1134 may be implemented by a combination of software components (e.g., executed by a DSP or a general processor) and hardware components (e.g., logic gates and circuitry) within the processor(s) 1122 or the transceiver(s) 1128.

The beam management module(s) 1134 may be used for various aspects of the present disclosure, for example, aspects of FIGS. 1-9, from a network device perspective. The beam management module(s) 1134 may be configured to, for example, receive reports of predicted Tx beams from a wireless device, transmit reference signals to the wireless device, and determine QCL information for signals transmitted to the wireless device (e.g., the wireless device 1102).

For one or more embodiments, at least one of the components set forth in one or more of the preceding figures may be configured to perform one or more operations, techniques, processes, and/or methods as set forth herein. For example, a baseband processor (or processor) as described herein in connection with one or more of the preceding figures may be configured to operate in accordance with one or more of the examples set forth herein. For another example, circuitry associated with a UE, network device, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form described. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus comprising memory coupled to a processor, the processor configured to:
receive, an indication of a set of transmit (Tx) beams of a network device;
generate a set of measurements based on a set of reference signals, the set of reference signals received from the network device on at least one beam of the set of Tx beams;
determine, at least partly based on the set of measurements and using artificial intelligence (AI), a set of predicted Tx beams that is best received by the UE, the set of predicted Tx beams including one or more Tx beams outside the set of Tx beams; and
generate, for transmission, a report identifying the set of predicted Tx beams.

2. The apparatus of claim 1, wherein the report identifies each Tx beam in the set of predicted Tx beams by at least a horizontal beam angle and a vertical beam angle.

3. The apparatus of claim 1, wherein the report associates each predicted Tx beam in the set of predicted Tx beams with a corresponding receive (Rx) beam of the UE.

4. The apparatus of claim 1, wherein:
the processor is configured to,
generate a second set of measurements based on a second set of reference signals, received from the network device on at least one Tx beam of the set of predicted Tx beams;
generate, for transmission, a report based at least in part on the second set of measurements; and
receive, an indication of at least one Tx beam for receiving a data channel or a control channel.

5. The apparatus of claim 4, wherein the processor is configured to receive, prior to generating the second set of measurements, an indication that the second set of reference signals will be transmitted on at least one predicted Tx beam identified in the report.

6. The apparatus of claim 5, wherein the indication that the second set of reference signals will be transmitted on at least one predicted Tx beam identified in the report includes an indication of a receive time of uplink control information (UCI) carrying the report.

7. The apparatus of claim 6, wherein the processor is configured to determine the receive time from an acknowledgement (ACK) indication for a physical uplink shared channel (PUSCH) carrying the UCI.

8. The apparatus of claim 6, wherein the processor is configured to determine the receive time from a receive time of a physical uplink shared channel (PUSCH) carrying the UCI.

9. The apparatus of claim 6, wherein the processor is configured to determine the receive time from a would-be physical uplink control channel (PUCCH) receive time before UCI multiplexing over a PUCCH or a physical uplink shared channel (PUSCH).

10. The apparatus of claim 5, wherein the indication that the second set of reference signals will be transmitted on at least one predicted Tx beam identified in the report is associated with a selection of a predicted Tx beam or predicted Tx beams within the report.

11. The apparatus of claim 4, wherein the processor is configured to determine a quasi-co-location (QCL) property of a reference signal in the second set of reference signals, the reference signal received on a predicted Tx beam of the set of predicted Tx beams, and the QCL property determined based at least in part on a set of QCL properties of one or more reference signals received on one or more neighbor Tx beams of the predicted Tx beam.

12. The apparatus of claim 11, wherein the QCL property is determined using a function identified in a 3rd Generation Partnership Project (3GPP) technical specification.

13. The apparatus of claim 11, wherein the QCL property is determined using a UE-specific function.

14. The apparatus of claim 11, wherein the QCL property is determined from a transmission configuration indicator (TCI) state for the reference signal.

15. The apparatus of claim 11, wherein the processor is configured to determine the one or more neighbor Tx beams of the predicted Tx beam from a range of horizontal beam angles and a range of vertical beam angles identifying the one or more neighbor Tx beams.

16. The apparatus of claim 1, wherein the processor is configured to transmit, prior to receiving the indication of the set of Tx beams of the network device, a set of UE capabilities pertaining to Al prediction for beam management.

17. The apparatus of claim 1, wherein:
the indication of the set of Tx beams of the network device includes, a first indication of a first set of Tx beams on which the network device is configured to transmit; and
a second indication of a second set of Tx beams, the second set of Tx beams a subset of the first set of Tx beam, the second indication associated with a quasi-co-location (QCL) property.

18. The apparatus of claim 17, wherein the second set of Tx beams is indicated within a definition of a transmission configuration indicator (TCI) state.

19. The apparatus of claim 17, wherein the second set of Tx beams is indicated in a medium access control (MAC) control element (CE) (MAC CE) or downlink control information (DCI) linked to a transmission configuration indicator (TCI) state.

20. An apparatus comprising memory coupled to a processor, the processor configured to:
transmit, to a user equipment (UE), an indication of a set of transmit (Tx) beams of the network device;
generate, for transmission, a set of reference signals, the set of reference signals transmitted on at least one beam of the set of Tx beams; and
receive, from the UE, a report identifying a set of predicted Tx beams, the set of predicted Tx beams including one or more Tx beams outside the set of Tx beams.
